(19) United States
(12) Patent Application Publication
(10) Pub. No.: US 2006/0129496 A1
(43) Pub. Date: Jun. 15, 2006

(54) Method and apparatus for providing digital rights management

(75) Inventors: Richard T. Chow, Santa Clara, CA (US); Sanjay K. Jain, Cupertino, CA (US)

Correspondence Address: VEDDER PRICE KAUFMAN & KAMMHOLZ, 222 N. LASALLE STREET, CHICAGO, IL, 60601, US

(73) Assignee: Motorola, Inc., Schaumburg, IL (US)

(21) Appl. No.: 11/011,860

(22) Filed: Dec. 14, 2004

(51) Int. Cl. G06F 17/60

(52) U.S. Cl. 705/59

(57) ABSTRACT

A method and wireless mobile device employs a virtual file system (706) and a digital rights management file system (708), at an operating system level, and a user space digital rights manager (712), at an application or user space level. The user space digital rights manager (712) is operative to manage digital rights associated with content that is stored in the digital rights management file system (708). For example, although an application may request content that has digital rights associated with it from the virtual file system (706), and the virtual file system (706) communicates with the digital rights management file system (708) at the operating system level, the DRM file system (708) redirects the calls to the user space digital rights manager (712) at the user space level which performs the digital rights operations.

### FIELD OF THE INVENTION

The present invention relates generally to the field of apparatus and methods for managing digital rights for content and more particularly to methods and apparatus for providing digital rights management for mobile wireless devices.

### BACKGROUND OF THE INVENTION

Computing devices and other devices may have different capabilities and features based on the applications installed in their memory. Firmware and applications may be pre-installed to a computing device before purchase by a customer or installed after purchase by a customer or service technician via a storage media, such as a magnetic or optical disk. For computing devices that communicate with a computer network, applications may be installed after a customer or service technician downloads the applications to the computing device.

Users of wireless communication devices frequently download content that requires digital rights management to control the storage, playback and use of digital content. For example, digital rights management (DRM) deals with definition and enforcement of rights associated with particular objects, such as digital media content. The digital media content may be in the form of files or any other suitable format. Producers of digital media may benefit by offering fine grained means of pricing and control and consumers may benefit by having the ability to pay only for their usage and tailor their purchase according to their needs. A simplified DRM solution such as the open mobile alliance (OMA) DRM solution may be suitable for low to medium valued content and provides a content provider several methods to protect content downloaded through the Internet or other network to a mobile client device such as a wireless mobile device.

Some digital rights management methods include forward lock, the ability to disable the forwarding of content to another process within the device for example; combined delivery, where the rights and content are delivered together; and separate delivery, where rights and content are delivered separately such as in two different files. Typical rights include the ability to perform an action, such as playing content, either a specified number of times or in a specified time interval. Separate delivery may have the content encrypted so that it is difficult to use the content without the decryption key.

Several existing solutions attempt to control access to protected content but they typically require modifications to an operating system to make the digital rights management more secure. For example, a file system at the operating system level may be used to decrypt content and pass it directly to a process or application for playback in the case of audio or video content.

A known DRM solution utilizes a special digital rights management file system in kernel space, (i.e. the operating system level) to perform digital right management operations such as decryption of content and the decrementing of usage counts for example so that if content is limited to two usages, a counter is maintained to prevent further access after the content has been accessed twice. Moreover with digital rights management operations being performed at the operating system level, an error in the digital rights management system can shut down the entire operating system.

If desired, it would be desirable to not require for example an application to keep track of content usage. Also, it would be beneficial if desired, to avoid substantioal modifications to an operating system to affect digital rights management for content. Therefore, a need exists for an apparatus and method for providing digital rights management in a wireless device.

### BRIEF DESCRIPTION OF THE DRAWINGS

FIG. 1 is a schematic view illustrating an embodiment of a wireless communication system in accordance with the present invention.

FIG. 2 is a schematic view illustrating another embodiment of the wireless communication system in accordance with the present invention.

FIG. 3 is a block diagram illustrating exemplary internal components of various servers, controllers and devices that may utilize the present invention.

FIG. 4 is a block diagram representing the functional layers of a client device in accordance with the present invention.

FIG. 5 is a block diagram illustrating an embodiment of the functional layers of the client device in accordance with the present invention.

FIG. 6 is a block diagram illustrating another embodiment of the lower level functional layers of the client device in accordance with the present invention.

FIG. 7 is a block diagram illustrating one example of a wireless mobile device employing a digital rights management system in accordance with one embodiment of the invention.

FIG. 8 is a flowchart illustrating one example of a method for providing digital rights management in a wireless mobile device in accordance with one embodiment of the invention.

FIG. 9 is a flowchart illustrating one example of a method for providing digital rights management in a wireless mobile device in accordance with one embodiment of the invention.

### DETAILED DESCRIPTION OF THE PREFERRED EMBODIMENTS

A method and wireless mobile device employs a virtual file system and a digital rights management file system, at an operating system level, and a user space digital rights manager, at an application or user space level. The user space digital rights manager is operative to manage digital rights associated with content that is stored in the digital rights management file system. For example, although an application may request content that has digital rights associated with it from the virtual file system, and the virtual file system communicates with the digital rights management file system at the operating system level, the DRM file system redirects the calls to the user space digital rights manager at the user space level which performs the digital rights operations.

In one embodiment, the digital rights management file system is a partitioned digital rights file directory and a file handler determines whether a downloaded file is to be stored in the digital rights management file system based on, for example, file extension data or MIME type data, or any other suitable data.

The user space digital rights manager is a type of pluggable file system module at the user space level that enforces digital rights. For example, objects related to digital rights management are accessed via existing file system interfaces (e.g., POSIX open, read and write calls) used for non-digital right management objects. Digital rights management objects, such as content files or digital rights management files, are stored in the partitioned and special part of the OS file system. In one example, a Linux operating system is utilized to allow the pluggable user space digital rights manager to suitably interface with the digital rights management file system. The user space digital rights manager manages the actual storage of content files and updates digital rights management files if present and maintains associations between the content file and an associated rights file. Also, only trusted software applications are allowed access to the content files.

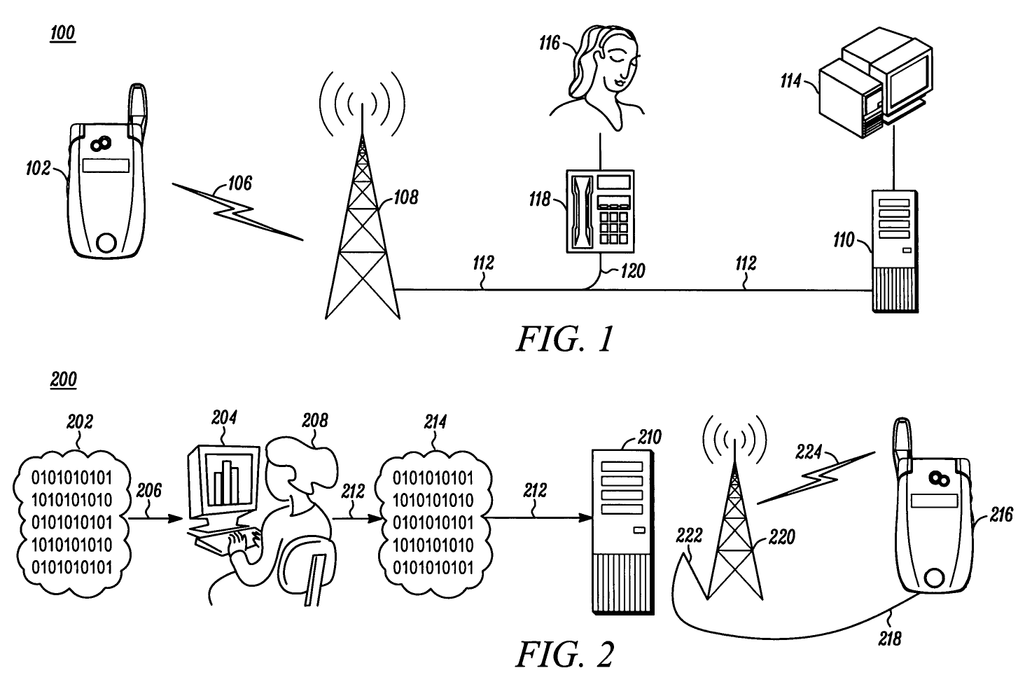

Referring to FIG. 1, there is provided a schematic view illustrating an embodiment of a wireless communication system 100. The wireless communication system I 00 includes a wireless communication device 102 communicating with a wireless communication network 104 through a wireless link 106. Any type of wireless link 106 may be utilized for the present invention, but it is to be understood that a high speed wireless data connection is preferred. For example, the wireless communication network 104 may communicate with a plurality of wireless communication devices, including the wireless communication device 102, via a cellular-based communication infrastructure that utilizes a cellular-based communication protocols such as AMPS, CDMA, TDMA, GSM, iDEN, GPRS, EDGE, UMTS, WCDMA and their variants. The wireless communication network 104 may also communicate with the plurality of wireless communication devices via a peer-to-peer or ad hoc system utilizing appropriate communication protocols such as Bluetooth, IEEE 802.11, IEEE 802.16, and the like.

The wireless communication network 104 may include a variety of components for proper operation and communication with the wireless communication device 102. For example, for the cellular-based communication infrastructure shown in FIG. 1, the wireless communication network 104 includes at least one base station 108 and a server 110. Although a variety of components may be coupled between one or more base stations 108 and the server 110, the base station and server shown in FIG. 1 is connected by a single wired line 112 to simplify this example.

The server 110 is capable of providing services requested by the wireless communication device 102. For example, a user of the device 102 may send a request for assistance, in the form of a data signal (such as text messaging), to the wireless communication network 106, which directs the data signal to the server 110. In response, the server 110 may interrogate the device and/or network state and identify one or more solutions. For those solutions that require change or correction of a programmable module of the device 102, the server 110 may send update data to the device via the wireless link 106 so that the programmable module may be updated to fulfill the request. If multiple solutions are available, then the server 110 may send these options to the device 102 and await a response from the device before proceeding.

The wireless communication system 100 may also include an operator terminal 114, managed by a service person 116, which controls the server 110 and communicates with the device 102 through the server. When the server 110 receives the request for assistance, the service person may interrogate the device and/or network state to identify solution(s) and/or select the best solution if multiple solutions are available. The service person 116 may also correspond with the device 102 via data signals (such as text messaging) to explain any issues, solutions and/or other issues that may be of interest the user of the device.

The wireless communication system 100 may further include a voice communication device 118 connected to the rest of the wireless communication network 104 via a wired or wireless connection, such as wired line 118, and is available for use by the service person 116. The voice communication device 118 may also connect to the network via the server 110 or the operator terminal 114. Thus, in reference to the above examples, a user of the device 102 may send a request for assistance, in the form of a voice signal, to the wireless communication network 106, which directs the data signal to the server 110. While the server 110 and or the service person 116 is interrogating the device and/or network state, identifying one or more solutions, and/or selecting an appropriate solution, the service person may correspond with the device 102 via voice signals to explain any issues, solutions and/or other issues that may be of interest the user of the device.

Referring to FIG. 2, there is provided a schematic view illustrating another embodiment of the wireless communication system. For this embodiment, operator requirements 202 are received by a service terminal 204 via a first connection 206 and a service person 208 operates the service terminal 204, if necessary. For example, the service person 208 may provide information about a desired operator and/or needs of a device user so that the appropriate operator requirements 202 are received. The service terminal 204 may optionally be connected to a server 210 by a second connection 212. Regardless of whether the server 210 is used, the service terminal 204 generates appropriate components that should be sent to a wireless communication device 216 operated by the user in accordance with the operator requirements 202 and associated information. The device 216 may be coupled to the service terminal 204 or the server 210 via a wired connection 218, such as a cable or cradle connection to the device's external connector, or a wireless connection. The wireless connection may include a wireless communication network that includes a base station 220 connected to the service terminal 204 or the server 210 and a wireless link 224 communication with the device 216.

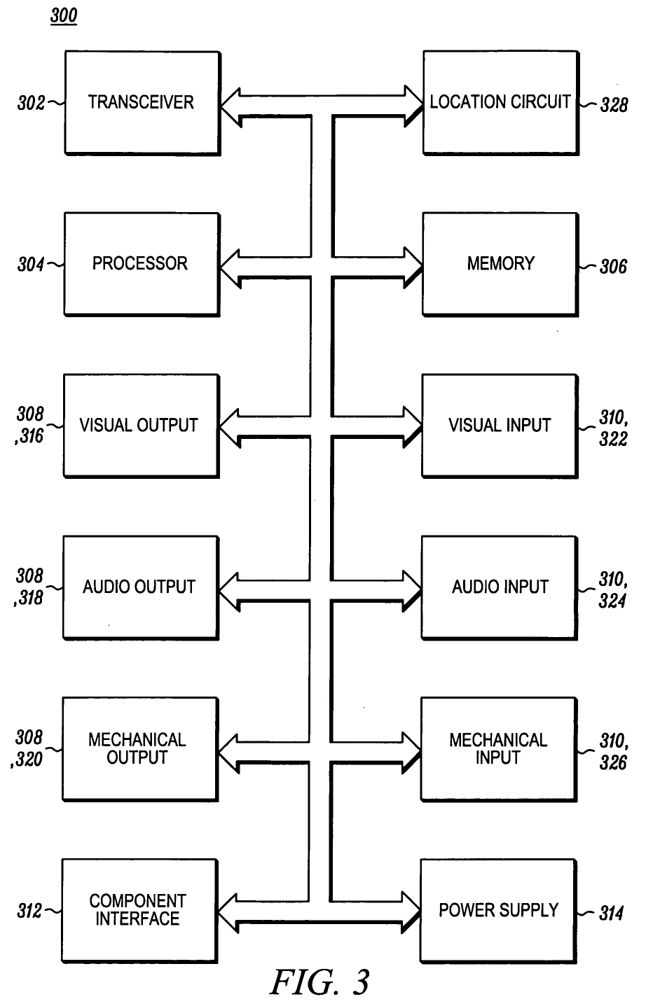

Referring to FIG. 3, there is provided a block diagram illustrating exemplary internal components of various servers, controllers and devices that may utilize the present invention, such as the wireless communication devices 102, 316 and the servers 110, 310 of FIGS. I and 2. The exemplary embodiment includes one or more transceivers 302, a processor 304, a memory portion 306, one or more output devices 308, and one or more input devices 310. Each embodiment may include a user interface that comprises at least one input device 310 and may include one or more output devices 308. Each transceiver 302 may be a wired transceiver, such as an Ethernet connection, or a wireless connection such as an RF transceiver. The internal components 300 may further include a component interface 312 to provide a direct connection to auxiliary components or accessories for additional or enhanced functionality. The internal components 300 preferably include a power supply 314, such as a battery, for providing power to the other internal components while enabling the server, controller and/or device to be portable.

Referring to the wireless communication devices 102, 316 and the servers 110, 310 of FIGS. 1 and 2, each machine may have a different set of internal components. Each server 110, 310 may include a transceiver 302, a processor 304, a memory 306 and a power supply 314 but may optionally include the other internal components 300 shown in FIG. 2. The memory 306 of the servers 110, 310 should include high capacity storage in order to handle large volumes of media content. Each wireless communication device 102, 316 must include a transceiver 302, a processor 304, a memory 306, one or more output devices 308, one or more input devices 310 and a power supply 314. Due to the mobile nature of the wireless communication devices 102, 316, the transceiver 302 should be wireless and the power supply should be portable, such as a battery. The component interface 312 is an optional component of the wireless communication devices 102, 316.

The input and output devices 308, 310 of the internal components 300 may include a variety of visual, audio and/or mechanical outputs. For example, the output device(s) 308 may include a visual output device 316 such as a liquid crystal display and light emitting diode indicator, an audio output device 318 such as a speaker, alarm and/or buzzer, and/or a mechanical output device 320 such as a vibrating mechanism. Likewise, by example, the input devices 310 may include a visual input device 322 such as an optical sensor (for example, a camera), an audio input device 324 such as a microphone, and a mechanical input device 326 such as a flip sensor, keyboard, keypad, selection button, touch pad, touch screen, capacitive sensor, motion sensor, and switch.

The internal components 300 may include a location circuit 328. Examples of the location circuit 328 include, but are not limited to, a Global Positioning System (GPS) receiver, a triangulation receiver, an accelerometer, a gyroscope, or any other information collecting device that may identify a current location of the device.

The memory portion 306 of the internal components 300 may be used by the processor 304 to store and retrieve data. The data that may be stored by the memory portion 306 include, but is not limited to, operating systems, applications, and data. Each operating system includes executable code that controls basic functions of the communication device, such as interaction among the components of the internal components 300, communication with external devices via the transceiver 302 and/or the component interface 312, and storage and retrieval of applications and data to and from the memory portion 306. Each application includes executable code utilizes an operating system to provide more specific functionality for the communication device, such as file system service and handling of protected and unprotected data stored in the memory portion 306. Data is non-executable code or information that may be referenced and/or manipulated by an operating system or application for performing functions of the communication device.

The processor 304 may perform various operations to store, manipulate and retrieve information in the memory portion 306. Each component of the internal components 300 is not limited to a single component but represents functions that may be performed by a single component or multiple cooperative components, such as a central processing unit operating in conjunction with a digital signal processor and one or more input/output processors. Likewise, two or more components of the internal components 300 may be combined or integrated so long as the functions of these components may be performed by the communication device.

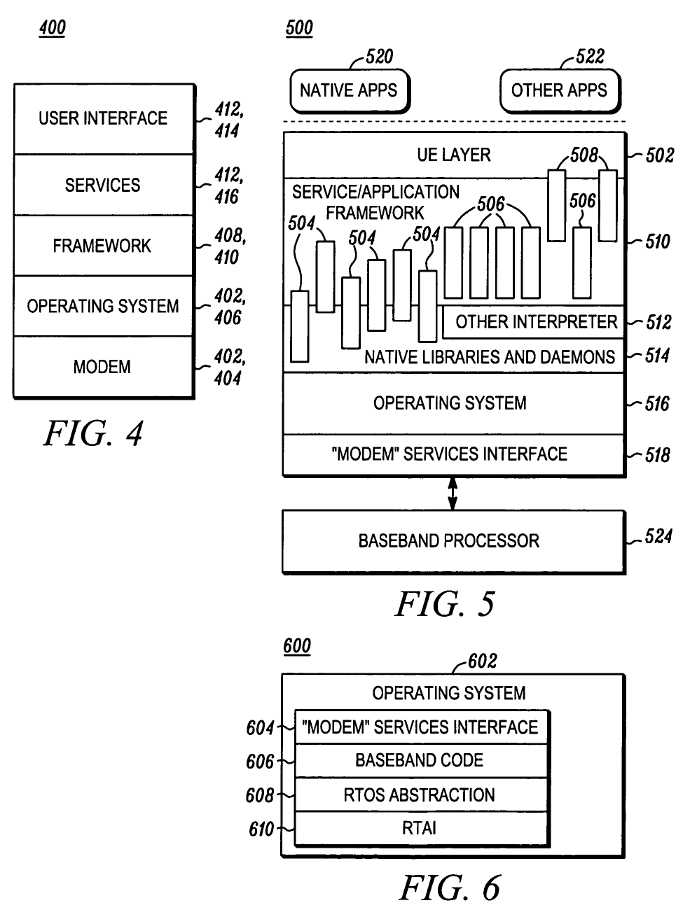

In accordance with the present invention, an expansion of known frameworks for more suitability to a wireless device operability is disclosed herein. FIG. 4, illustrates a basis architecture of a mobile device in accordance with the present invention. Existing known mobile devices are typically architected such that applications are loaded on top of a fixed base platform. APIs for applications are fixed at manufacture. Therefore it is not possible to postpone, for example, new media types and/or other upgrades. Turning to FIG. 4, a mobile device of the present invention utilizes an open OS, such as for example, Linux or Windows. Additionally, a modem interface is abstracted such that it is agnostic to the particular interface, for example radio interfaces such as GSM, CDMA, UMTS, etc. that would traditionally utilize dedicated functionality.

Referring to FIG. 4, there is provided a block diagram generally representing functional layers 400 included in the memory portion 306 (shown in FIG. 3) of a client device, such as the wireless communication device 102, 216. The functional layers 400 include low-level layers 402 including a modem layer 404 and an operating system layer 406, a mid-level layer 408 also known as a framework layer 410, and high-level layers 412 including a user interface layer 414 and a services layer 416. The modem layer 404 may be an abstracted interface to a modem circuit of the client device in which services are accessed through message passing. The modem layer 404 may be air-interface agnostic, i.e., may operate using a wide variety of air interface protocols. The modem layer 404 may also be an abstracted interface to an RTOS, and executive application programming interfaces (API's) may be encapsulated in a thin interface layer. Further, the modem code may be on a separate processor or co-resident with application code.

The operating system layer 406 operates above the modem layer 404 and provides basic platform services for the client device, such as process management, memory management, persistent storage (file system), Internet networking (TCP/IP), and native access security and application-to-application protection. The operating system layer 406 may expose native services based upon standards-defined API's (POSIX). The operating system layer 406 may host native applications, such as system daemons, specific-language interpreters (such as JAVA), and second-party native applications (such as a browser). Daemons are executable code that run as separate background processes and provide services to other executable code(s) or monitor conditions in the client device.

The framework layer 410 provides an operable interface between the low-level layers 402 and the high level layers 412 that provides ample opportunities for current and future functions and, yet, is efficient enough to avoid provide unnecessary code that may waste precious memory space and/or slow-down the processing power of the client device. Key features of the framework layer 410 may include, but are not limited to, hierarchical class loaders, application security, access to native services, and compilation technology for performance. Although the operating system layer 406 may host system daemons and specific-language interpreters, the framework layer 410 should actually include such system daemons and specific-language interpreters. The framework layer 410 may also include a framework for managing a variety of services and applications for the client device. For one embodiment, the framework layer 410 is an always-on CDC/FP/PBP JVM, OSGi framework.

The services layer 416 is adapts the framework layer 410 to wireless communication services. The services layer 416 includes services packaged in modular units that are separately life-cycle managed (e.g., start, stop, suspend, pause, resume); are separately provisioned, upgraded and withdrawn; and abstracts the complexity of the service implementation from a user of the client device. Services are modular, extensible and postponeable so that, within the services layer 416, services may be added, upgraded and removed dynamically. In particular, the services layer 416 includes a lookup mechanism so that services may discover each other and applications may discover services used by other services, e.g., service provider interfaces (SPI's), and services used by applications, e.g., application programming interfaces (API's).

An API is a formalized set of function and/or method calls provided by a service for use by a client device, whereas an SPI is a set of interfaces and/or methods implemented by a delegated object (also called provider) providing an API to the client device. If an API is offering methods to client devices, more API's may be added. Extending the functionality to offer more functionality to client devices will not hurt them. The client device will not use API's that are not needed. On the other hand, the same is not true for SPI's. For SPI's, the addition of a new method into an interface that others must provide effectively breaks all existing implementations.

The user interface layer 414 manages applications and the user interface for the client device. The user interface layer 414 includes lightweight applications for coordinating user interaction among the underlying services of the services layer 416. Also, the user interface layer 414 is capable of managing native applications and language-specific application, such as JAVA. The user interface layer 414 creates a unifying environment for the native applications and the language-specific applications so that both types of applications have a similar “look and feel”. The native applications utilize components of a native toolkit, and the language-specific applications utilized components of a corresponding language-specific toolkit. For the user interface layer 414, a language-specific user interface toolkit is built on the native toolkit, and MIDlets are mapped to the language-specific user interface toolkit.

FIG. 5 illustrates details of a mobile device architecture, having dual processors, in accordance with some embodiments of the present invention. In FIG. 5 a Service/Application Framework provides services such as but not limited to; messaging, security, DRM, device management, persistence, synchronization, and power management. An abstracted modem service interface communicates with the baseband processor, wherein the baseband processor may communicate over any suitable radio interface. In FIG. 5, the UE Layer, may be implemented for example in Java. The Operating System is an open operating system and may utilize for example Linux or Windows.

Unlike prior art architectures, as previously mentioned, wherein applications are loaded on top of a fixed base platform, applications as shown in the embodiments illustrated by FIG. 5 are architected in a more flexible structure. In accordance with the embodiments of FIG. 5, application and feature upgrades, new content types, new standards-based upgrades, new operator specific service libraries, and component upgrade and repair are facilitated.

Referring to FIG. 5, there is provided a block diagram illustrating a first client embodiment 500 included in the memory portion 306 of the client device, such as the wireless communication device 102, 216. The first client embodiment 500 includes a UE layer 502, a plurality of services 504, 506, 508, a service/application framework 510, an other or language-specific interpreter 512 (such as JAVA Virtual Machine), native libraries and daemons 514, an operating system 516, and a modem services interface 518. The UE layer 502 interacts with native applications 520 and language-specific applications 522, such as JAVA. The modem services interface interacts 518 with a baseband processor 524 of the client device.

The applications are user-initiated executable code whose lifecycle (start, stop, suspend, pause, resume) may be managed. The applications may present a User Interface and/or may use services. Each daemon is an operating system (OS) initiated, executable code that runs as a separate background process. Daemons may provide services to other executable code or monitor conditions in the client.

There is organizational cooperation of the services 504, 506, 508 with the mid-level layer 408 which includes the service/application framework 510, the language-specific interpreter 512 and the native libraries and daemons 514 as well as the UE layer 502. As represented by FIG. 5, the types of available services include native-based services 504 which rely on one or more components of the native libraries and daemons 514, language-specific services 506 which rely on components associated with the language-specific interpreter 512, and native or language-specific services 508 that further rely on components of the UE layer 502.

A service is a set of functionality exposed via a well-defined API and shared among applications. A service has as least two characteristics, namely a service interface and a service object. The service interface is the specification of the service's public methods. The service object implements the service interface and provides the functionality described in the interface. A service may provide methods that present a User Interface. Invoking a method on a service is done in the caller's context (thread/stack). Services may return a value to the requesting client by depositing it on the caller's stack, unlike an invoked application. The implementation of the service may be replaced without affecting its interface Examples of services include, but are not limited to, messaging, security, digital rights management (DRM), device management, persistence, synchronization and power management.

A system service is a low-level service specific to an operating system or MA and is not part of the abstract set of services exposed to platform components. System service APIs should not be used by any component that is intended to portable across all instantiations of the platform. A framework service is a service that exposes a higher level abstraction over system services and provides OS-independent and MA-independent access to infrastructure components and services. An application service is a service that exposes application-specific functionality (both UI and non-UI) via a well defined API. A native service is a service written in native code.

A library is a set of services contained in an object that can either be statically linked or dynamically loaded into executable code. Library services may invoke other library services or services contained in daemons, which are external to the library and may also run in a different process context.

Referring to FIG. 6, there is provided a block diagram illustrating a second client embodiment 600 of the lower level functional layers of the client device. The first client embodiment 500 represents a dual processor architecture of a client device, whereas the second client embodiment 600 represents a single core architecture of a client device. For the second client embodiment 600, the operating system 602 includes the modem services interface 604 and a baseband code 606. In addition, the operating system 602 may include other components, such as an RTOS abstraction 608 and an RTAI 610.

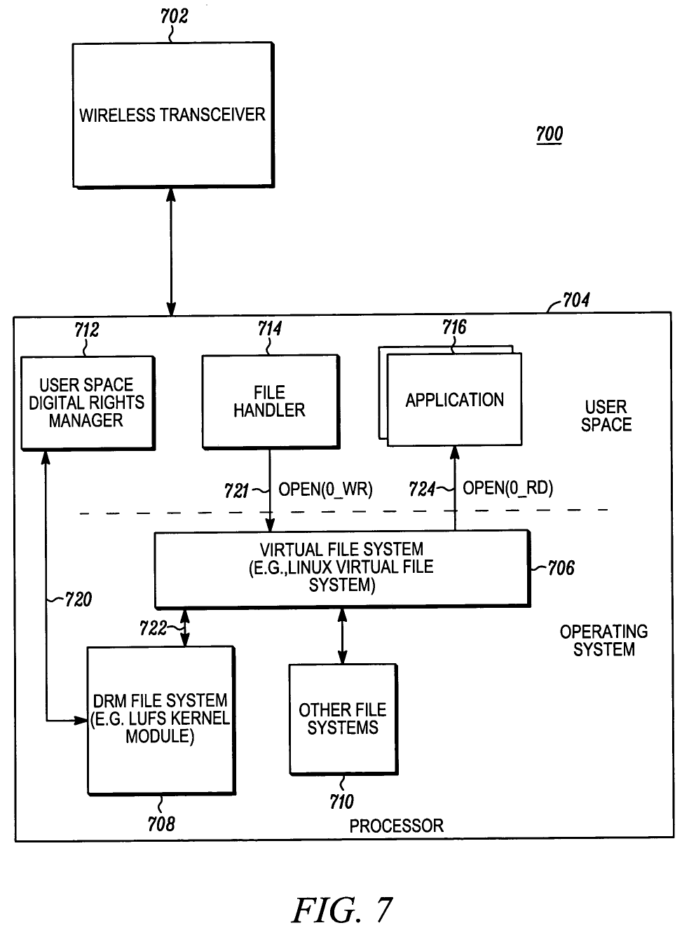

FIG. 7 is a block diagram of one example of a wireless communication device such as a wireless mobile device 700 that includes suitable memory 306 for storing application code and operating system code in the form of executable instructions that when executed by one or more processors performs the functions as described herein. The wireless mobile device 700 includes a conventional wireless transceiver 702 for wirelessly sending and receiving information to another wireless mobile device either directly or through a suitable network as described earlier. In addition, the wireless mobile device includes a processor 704 (i.e. one or more) which is suitably programmed to include a virtual file system 706, a digital rights management file system 708 and any other suitable file systems shown as 710, as part of an operating system and hence at an operating system level. For purposes of illustration only, the wireless mobile device 700 will be described as having a Linux operating system. However, any other suitable operating system may also be employed. It will also be recognized that the wireless mobile device includes other components and operations not shown for purposes of simplicity. The wireless mobile device 700 also includes a user space digital rights manager 712, a file handler 714 and one or more software applications 716 at a user space level. The digital rights management file system 708 and the virtual file system 706 communicate using conventional Linux communication techniques and the virtual file system 706 may be a Linux virtual file system.

The user space digital rights manager 712 may be a software module executing on the processor and is operative to manage digital rights associated with content that is stored, for example, in the digital rights management file system 708. As shown, the user space digital rights manager 712 communicates with the digital rights management file 708 through suitable calls 720.

In this example, the user space digital rights manager 712 may be implemented as a type of Linux user-space process that manages the subdirectory, namely the DRM file system 708. Moreover, it will be recognized that any suitable structure may be used.

The virtual file system 706 acts as a switch between the DRM file system 708 and other file system 710 and hands off requests to the different file systems that are received from the application 716. The DRM file system 708 may be implemented as a Linux user and file system kernel module whereas the user space digital rights manager 712 is a plugable code module that performs digital rights management functions such as the decryption and encryption of content stored in the digital rights management file system, usage tracking advantages desired digital rights operatives.

The file handler 714 may be for example an MIME handler that checks files to be stored in the file system to determine which partitioned file system the files should be stored in. As applied to the digital rights management operation, the content that is to be stored in the digital right management file system may have a “.dm” file extension and as such the file handler 714 knows to store the content file with this extension in the DRM file system 708. For example, regular content may be stored as a file in the DRM file system in a DRM file system directory and separate delivery of a digital rights file is written to the same directory. Alternatively, when the digital rights information is imbedded with-the content, the file handler 714 strips the digital rights management bytes from the content file and stores them as separate digital rights management data in the same directory that contains the content or the corresponding content. The user space digital rights manager 712 also performs other conventional digital rights management function such as preventing untrusted applications from gaining access to the DRM file system 708.

The user space digital rights manager 712 is operative to decrypt content stored in the content file using a corresponding decryption key on behalf of a trusted application. As known in the art the decryption key may be stored in the digital rights management file, embedded in the content or may come from another source.

The file handler 714 stores (writes) the content file and any associated digital rights file into the partition digital rights file directory based on file extension data, MIME type data, or any other suitable data as shown by call 721.

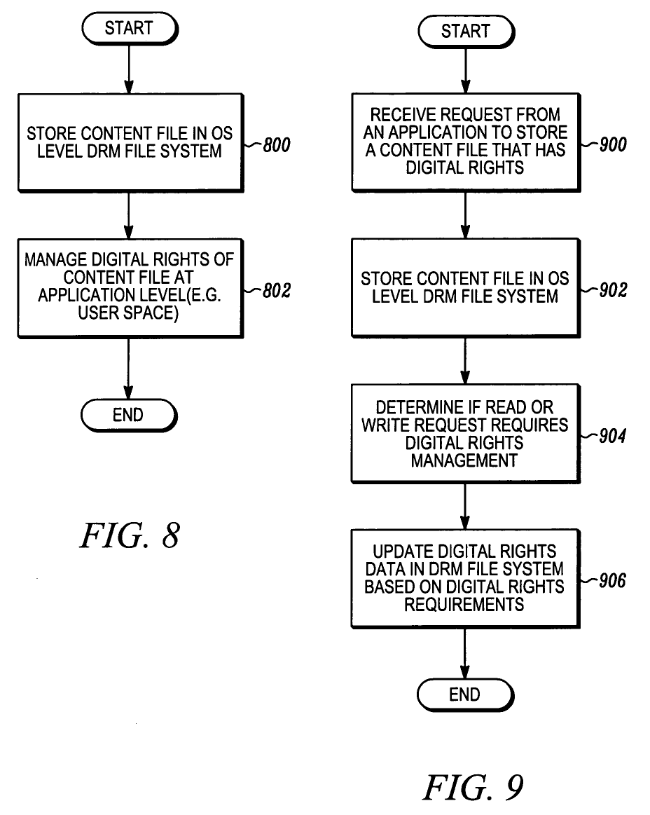

As shown in FIG. 8, a method for providing digital rights management in a wireless mobile device, such as the one shown in FIG. 3 is shown. As shown in block 800, the method includes storing a content file in an operating system level DRM file system 708. This may be done, for example, by the file handler 714 based on a file extension. As shown in block 802, the method includes managing digital rights of the content file at an application level, which is performed, for example, by the user space digital rights manager 712. As such, although a digital rights management file system 708 is employed, it does not perform digital rights management operations. For example, the virtual file system 706 asks through suitable calls 722 the digital rights management file system 708 for read data when an application requests to read data 724 from the DRM file system. However, no decryption operation is performed by the DRM file system 708. Instead, the DRM file system 708 notifies the user space digital rights manager 712 through calls 720 that a read request was made and the user space digital rights manager then performs the suitable decryption. The virtual file system 706 however is basically unaware of the user space digital right manager's 712 operations. The user space digital rights manager 712 then passes the decrypted content back to the DRM file system 708 which then passes the decrypted content in response to the read request from the application through the virtual file system. As such, the DRM file system 708 and the user space digital rights manager 712 communicate with one another outside the virtual file system 706. The user space digital rights manager 712 also keeps track of usage information by incrementing or decrementing suitable counters if usage limitations are dictated by digital rights management file data. As such, the user space digital rights manager interprets a stored digital rights management file from the file system in order to perform the requisite digital rights management associated with content.

FIG. 9 illustrates a method for providing digital rights management in a wireless mobile device in accordance with one embodiment to the invention. As shown in block 900, the method includes receiving a request from a trusted application 716 or the file handler 712 to store a content file that has digital rights. The file handler 714, when a content file is downloaded, reads the file extension and determines if it is a digital rights management content file. If so, it is stored in the digital rights management file system 708 as shown in block 902. If not, then it is stored in one of the other file systems. The virtual file system allows the file handler 714 to store the content file in an OS level DRM file system 708. When the content file is downloaded with a corresponding digital rights management file, both files are stored in the DRM file system 708 under the same directory, as shown in block 904. The method includes determining if a read or write request from the application requires digital rights management. For example, if a trusted application wishes to read a file, the user space DRM manager 712 will provide the requisite digital rights control. As shown in block 906, if some digital rights management control is required, the digital rights manager will update the digital rights data in the digital rights management file system 708 to reflect any change in digital rights. For example, if the usage requirement is set so that a particular content file can be read only three times and it is read for a second time, the digital rights manager will update a counter and store the data in the requisite DRM file associated with the content file in the DRM file system to reflect the change in status. Other suitable digital rights control information may also be stored in the digital rights file in the DRM file system. As such, the method includes storing the content file and as a cited DRM file, (if present) in an operating system level digital rights management file system. As noted above, the digital rights management file system 708 includes a partitioned digital rights file directory which contains both the content file and a digital rights file (or other digital rights information in any other suitable form). In addition, the method includes managing, at an application level, digital rights associated with content that is stored in the DRM file system. This is performed, for example by, the user space digital rights manager. In addition, a digital rights manager may also perform encryption of content and then may store the encrypted content back in the DRM file system as desired. Any other suitable digital rights operations may also be performed. The method may also include determining whether a calling application is a trusted application that is authorized to access the partition digital rights file directory.

As such, for combined delivery where the digital rights are imbedded for example with the content file, the user space digital rights manager 712 stores the content separate from the rights object and checks the rights or digital rights file for validity of the access during the opening of the content. The digital rights manager has default actions associated with each file based on the MIME type and/or file extension of the files and these defaults can be overridden by bypassing related flags and the open file system call. For instance, a file containing a picture may have rights for printing and rights for viewing; the default action might be “viewing”, so if an application wanted to open the file for “printing” a flag should be passed in by the application to indicate this.

If there is no rights file, all applications are not allowed access to the content file and the digital rights manager can present an option to download digital rights from an appropriate source. If the digital rights file is present, the digital rights manager uses the digital rights file to decrypt the file and provides data from the decrypted file for reads by the applications.

Among other advantages, existing file system mechanisms, such as file permissions can be used to block unauthorized access to digital media objects. Authorized applications that use the defaults need not be changed. Operating systems such as Linux can support the user space digital rights manager which can be implemented in a user space module which may result in ease of development and debugging. The DRM file system includes a small generic kernel module for redirecting system calls. Other advantages will be recognized by those of ordinary skill of the art.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless mobile device comprising:
a virtual file system;
a digital rights management (DRM) file system in operative communication with the virtual file system; and
a user space digital rights manager operative to manage digital rights associated with content that is stored in the DRM file system.

2. The wireless mobile device of claim 1 wherein the digital rights manager is operative to decrypt content stored in the content file using a corresponding decryption key on behalf of a trusted application.

3. The wireless mobile device of claim 1 wherein the digital rights manager determines whether a calling application is a trusted application that is authorized to access the partitioned digital rights file directory.

4. The wireless mobile device of claim-1 wherein the DRM file system includes a partitioned digital rights file directory and wherein the device includes a file handler operative to store at least a content file and an associated digital rights file in a partitioned digital rights file directory.

5. The wireless mobile device of claim 4 where the file handler stores the content file and associated digital rights file into the partitioned digital rights file directory based on file extension data.

6. The wireless mobile device of claim 1 wherein the DRM file system is based on a Linux userland file system architecture.

7. A method for providing digital rights management in a wireless mobile device comprising:
receiving a request to store a content file that has digital rights management requirements associated therewith;
storing the content file in an operating system level digital rights management (DRM) file system that includes a partitioned digital rights file directory; and
managing, at an application level, digital rights associated with content that is stored in the DRM file system.

8. The method of claim 7 wherein managing digital rights includes at least one of: decrypting content stored in the content file using a corresponding decryption key on behalf of a trusted application, updating content usage data, encrypting content for storage in the DRM file system.

9. The method claim 8 including determining whether a calling application is a trusted application that is authorized to access the partitioned digital rights file directory.

10. The method of claim 8 wherein the DRM file system includes a partitioned digital rights file directory and wherein the method includes storing at least a content file and an associated digital rights file in the partitioned digital rights file directory.

11. The method of claim 10 including storing the content file and associated digital rights file into the partitioned digital rights file directory based on at least one of: file extension data and mime type.
